(19) United States
(12) Patent Application Publication
(10) Pub. No.: US 2019/0303874 A1
(43) Pub. Date: Oct. 3, 2019

(54) DETERMINING METRICS FOR ELECTRONIC COMMUNICATIONS TO IMPROVE ENGAGEMENT

(71) Applicant: Microsoft Technology Licensing, LLC, Redmond, WA (US)

(72) Inventors: Lin Yang, Sunnyvale, CA (US); Youming Liang, Santa Clara, CA (US); Nikhil Tayal, Mountain View, CA (US); Peter Hume Rigano, San Francisco, CA (US)

(21) Appl. No.: 15/941,217

(22) Filed: Mar. 30, 2018

(51) Int. Cl. G06Q 10/10; H04L 12/58; H04L 29/08; G06F 9/54; G06Q 50/00

(52) U.S. Cl. CPC G06Q 10/107; H04L 51/32; H04L 51/34; G06Q 10/1053; H04L 67/306; G06F 9/542; G06Q 50/01; H04L 67/22

(57) ABSTRACT

An online architecture includes various applications and platforms for determining metrics related to one or more electronic communications sent between members of an online service. The online architecture includes one or more front-end application(s) configured to provide one or more web page(s) or other graphical user interfaces for interacting with the disclosed systems and architecture. The online architecture also includes a stream processing platform and a distributed processing platform, where the stream processing platform handles volatile information and the distributed processing platform handles less volatile information. The stream processing platform and the distributed processing platform modify event records corresponding to the electronic messages. The event records are correlated to determine one or more metrics related to the one or more electronic communications. The online architecture further includes a uniform presentation platform for displaying the metrics relating to the electronic messages.

### TECHNICAL FIELD

The subject matter disclosed herein generally relates to an electronic communications platform and, in particular, modifying messages communicated between a sender and a recipient to determine and derive analytic information from the modified messages.

### BACKGROUND

As online platforms have become robust, they have become a hub for members to engage in different activities. One of the activities that online platforms provide is messaging. With messaging, members of the online service can communicate with each other. In some instances, a member communicates with another member. In other instances, a member communicates with a group of members. In either circumstance, the online service provides an easy mechanism by which one member can communicate with other members.

In a conventional messaging scenario, a sender will send a message to a recipient. The recipient will then have an opportunity to reply to the sender by replying to the received message. In some instances, the sender may be communicating with dozens or hundreds of other message recipients. For example, a recruiter may be communicating with potential recruits about one or more job opportunities. The recruiter may desire to track the types of recruits that he or she is communicating with and which messages the potential recruits are engaging with. Traditional electronic messaging or communications (e.g., conventional e-mail) does not capture these metrics nor does traditional electronic messaging or communications provide a measure as to which messages potential recruits are interacting with.

### BRIEF DESCRIPTION OF THE DRAWINGS

Some embodiments are illustrated by way of example and not limitation in the figures of the accompanying drawings.

FIG. 1 is a block diagram illustrating an online architecture in communication with one or more client devices in accordance with an example embodiment

FIG. 2 illustrates the online architecture of FIG. 1 in accordance with an example embodiment.

FIG. 3 is an illustration of a processing diagram, in accordance with an example embodiment, of the various application(s)/platform(s), shown in FIG. 2, for processing event records associated with one or more electronic communications.

FIGS. 4A-4B illustrate graphical user interfaces, in accordance with example embodiments, displaying analytical information derived by the platforms illustrated in FIG. 2.

FIGS. 5A-5B illustrate a method, in accordance with an example embodiment, for modifying a SEND event record associated with a message sent by a message sender using the online architecture of FIG. 1.

FIG. 6 illustrates a method, in accordance with an example embodiment, for modifying a REPLY event record associated with a message sent in reply to a message that was previously received.

FIG. 7 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

Example methods and systems are directed to monitoring and modifying event records associated with one or more electronic messages sent between members of an online system. In this context, an “event record” may be a file, a one- or two-dimensional array, a record comprising one or more variables of different data types, a table, or other logical construct that describes an interaction by a member with the online architecture. As discussed below, the online architecture may define different event record types, where each event record type is associated with a particular interaction with the online architecture.

In one embodiment, an online system includes one or more front-end application(s) configured to provide one or more web page(s) or other graphical user interfaces for interacting with the disclosed systems and architecture. The front-end application(s) may provide an electronic messaging interface for members of an online service to write and read electronic messages sent among each other. As the disclosed online architecture is configured to monitor interactions with the electronic messages (e.g., whether a sent electronic message was read by the recipient), the front-end application(s) may further provide one or more graphical user interfaces for reviewing analytical information derived from the interactions with the electronic messages.

The online architecture further includes a stream processing platform, a distributed processing platform, and a unified metrics pipeline. The stream processing platform is configured to manipulate and/or modify event records associated with the electronic messages in near real-time and/or immediately (e.g., a short duration) after such electronic messages are sent by a member of the online service. In one embodiment, the stream processing platform modifies one or more of the event records to include current information about the recipient of the one or more electronic messages. The current information may include keywords or other information that is relative to the recipient of the electronic message at or about the time the electronic message was sent to the recipient. In one embodiment, the stream processing platform is implemented using the Apache Samza framework, which is described at samza.apache.org, the disclosure of which is hereby incorporated by reference in its entirety.

The distributed processing platform is configured to process one or more electronic messages at a time after the one or more electronic messages are processed and/or modified by the stream processing platform. In one embodiment, the distributed processing platform modifies one or more sent electronic messages to include additional information about the recipient of the one or more electronic messages, where such additional information is not as time critical as the information added by the stream processing platform. The distributed processing platform may be implemented as Apache™ Hadoop®, which is available from the Apache Software Foundation. Unlike the stream processing platform, the distributed processing platform is configured to process one or more electronic messages after a predetermined time that the message was sent and, in some instances, after the message has been received by the recipient. In this manner, the electronic message may be delivered to the recipient prior to additional processing performed by the distributed processing platform, but after having been processed by the stream processing platform.

Both the stream processing platform and the distributed processing platform address technical problems arising out of generating meaningful metrics from the communication of electronic messages using the online architecture. As the electronic messages may be time critical, the stream processing platform is configured to modify the event records associated with such electronic messages with information relevant at the time the electronic message was sent. In contrast, the distributed processing platform adds additional information useful in analyzing and deriving various metrics from the electronic messages, where this additional information is not as time critical as the information added by the stream processing platform. Thus, the distributing processing platform can add such information during a daily or hourly routine of processing other information processing jobs, which may be requested by other platforms or services implemented by the online architecture.

By implementing a separate platform to handle the real-time, or near real-time, processing of the event records associated with one or more electronic messages, the online architecture reduces workload and time that the distributed processing platform would need to process the one or more electronic messages. Furthermore, the stream processing platform may have access to databases or other datastores where the information stored in such databases or datastores is subject to change on a frequent, or relatively frequent, basis. Thus, the disclosed systems and methods implement a technical solution arising out of a technical field of analyzing electronic messages and deriving metrics from the communication of such electronic messages, which is a technical field falling under the larger umbrella of computer information analytics and processing.

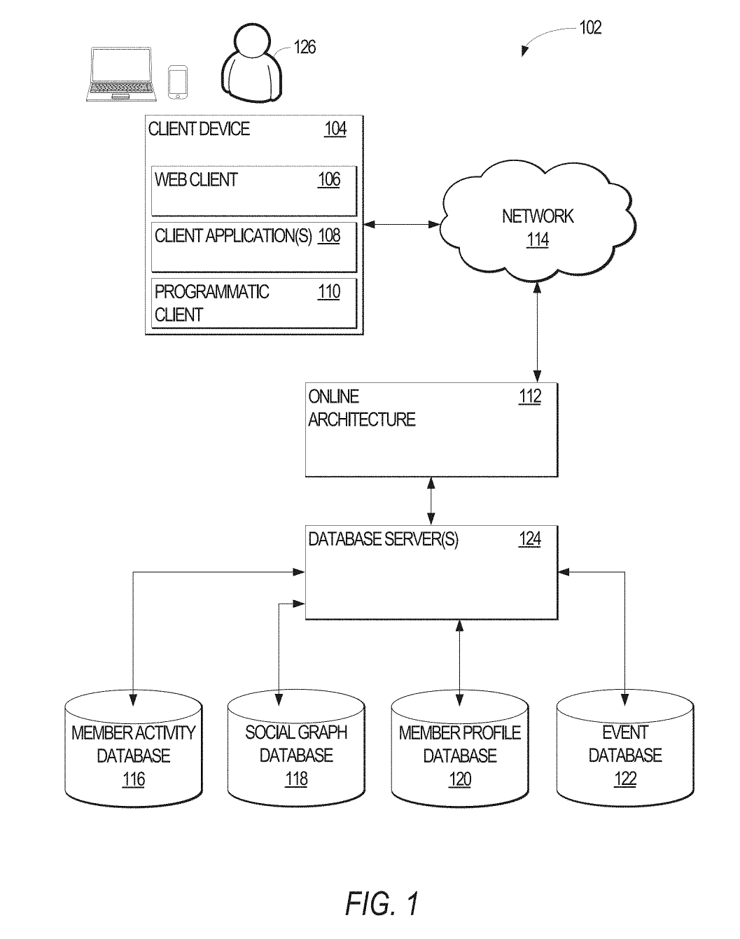

With reference to FIG. 1, an example embodiment of a high-level client-server-based network architecture 102 is shown. An online architecture 112 provides server-side functionality via a network 114 (e.g., the Internet or wide area network (WAN)) to one or more client devices 104. FIG. 1 illustrates, for example, a web client 106 (e.g., a browser, such as the Internet Explorer® browser developed by Microsoft® Corporation of Redmond, Wash. State), client application(s) 108, and a programmatic client 110 executing on client device 104. The online architecture 112 is further communicatively coupled with one or more database servers 124 that provide access to one or more databases 116-122. In one embodiment, the online architecture 112 is a social networking architecture that provides one or more social networking services to one or more members.

The client device 104 may comprise, but is not limited to, a mobile phone, desktop computer, laptop, portable digital assistant (PDA), smart phone, tablet, ultra book, netbook, laptop, multi-processor system, microprocessor-based or programmable consumer electronic, or any other communication device that a user 126 may utilize to access the online architecture 112. In some embodiments, the client device 104 may comprise a display module (not shown) to display information (e.g., in the form of user interfaces). In further embodiments, the client device 104 may comprise one or more of touch screens, accelerometers, gyroscopes, cameras, microphones, global positioning system (GPS) devices, and so forth. The client device 104 may be a device of a user 126 that is used to perform one or more searches for user profiles accessible to, or maintained by, the online architecture 112.

In one embodiment, the online architecture 112 is a network-based appliance or combination of network-based appliances that respond to initialization requests or search queries from the client device 104. One or more users 126 may be a person, a machine, or other means of interacting with the client device 104. In various embodiments, the user 126 is not part of the network architecture 102, but may interact with the network architecture 102 via the client device 104 or another means. For example, one or more portions of the network 114 may be an ad hoc network, an intranet, an extranet, a virtual private network (VPN), a local area network (LAN), a wireless LAN (ALAN), a WAN, a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The client device 104 may include one or more applications (also referred to as “apps”) such as, but not limited to, a web browser, messaging application, electronic mail (email) application, an online access client, and the like. In some embodiments, if the online access client is included in the client device 104, then this application is configured to locally provide the user interface and at least some of the functionalities with the application configured to communicate with the online architecture 112, on an as needed basis, for data and/or processing capabilities not locally available (e.g., access to a member profile, to authenticate a user 126, to identify or locate other connected members, etc.). Conversely if the online access client is not included in the client device 104, the client device 104 may use its web browser to access the initialization and/or search functionalities of the online architecture 112.

One or more users 126 may be a person, a machine, or other means of interacting with the client device 104. In example embodiments, the user 126 is not part of the network architecture 102, but may interact with the network architecture 102 via the client device 104 or other means. For instance, the user 126 provides input (e.g., touch screen input or alphanumeric input) to the client device 104 and the input is communicated to the client-server-based network architecture 102 via the network 114. In this instance, the online architecture 112, in response to receiving the input from the user 126, communicates information to the client device 104 via the network 114 to be presented to the user 126. In this way, the user 126 can interact with the online architecture 112 using the client device 104.

Further, while the client-server-based network architecture 102 shown in FIG. 1 employs a client-server architecture, the present subject matter is of course not limited to such an architecture, and could equally well find application in a distributed, or peer-to-peer, architecture system, for example.

In addition to the client device 104, the online architecture 112 communicates with other one or more database server(s) 124 and/or database(s) 116-122. In one embodiment, the online architecture 112 is communicatively coupled to a member activity database 116, a social graph database 118, a member profile database 120, and an event record database 122. The databases 116-122 may be implemented as one or more types of databases including, but not limited to, a hierarchical database, a relational database, an object-oriented database, one or more flat files, or combinations thereof.

The member profile database 120 stores member profile information about members who have registered with the online architecture 112. With regard to the member profile database 120, the member may include an individual person or an organization, such as a company, a corporation, a nonprofit organization, an educational institution, or other such organizations.

Consistent with some embodiments, when a person initially registers to become a member of the online service provided by the online architecture 112, the person is prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the member profile database 120. Similarly, when a representative of an organization initially registers the organization with the online service provided by the online architecture 112, the representative may be prompted to provide certain information about the organization. This information may be stored, for example, in the member profile database 120. With some embodiments, the profile data may be processed (e.g., in the background or offline) to generate various derived profile data. For example, if a member has provided information about various job titles the member has held with the same company or different companies, and for how long, this information can be used to inter or derive a member profile attribute indicating the member's overall seniority level, or seniority level within a particular company. With some embodiments, importing or otherwise accessing data from one or more externally hosted data sources may enhance profile data for both members and organizations. For instance, with companies in particular; financial data may be imported from one or more external data sources, and made part of a company's profile.

A member profile may also include information identifying one or more skills that a corresponding has identified as possessing. For example, the member may identify that he or she possesses computer programming skills (e.g., “Computer Programming, Debugging,” “C++,” etc.), writing skills (e.g., “Writing,” “Drafting,” etc. legal skills (e.g., “Contract drafting,” “Document review,” “Litigation,” etc.) and other such skills and/or combination of skills. In one embodiment, the member provides information to the online service via a graphical user interface (e.g., a webpage), which then updates the member's member profile with the provided skills. Additionally, and/or alternatively; the online service may provide a list and/or selectable skills that the member may identify as possessing. In this manner, a member profile includes skills that the member has identified as possessing.

The member profile data may further include a description or summary of the type of tasks and/or jobs that the member has performed during his or her career and/or associate them with one or more organizations. For example, the member may provide a description of the type of work that he or she has performed while employed at a given employer. Similarly, the member may provide a description of the type of courses and/or activities that he or she engaged in while attending a given educational institution (e.g., a university). Regardless of the organization type (e.g., educational, government, private company, non-profit, etc.), the online service provides a graphical user interface (e.g., a webpage) that allows the member to provide information about his or her duties and/or activities while attending or employed at a given organization. Thus, the member profile may be leveraged as a substitute rësumë for the corresponding member.

Members of the online service may establish connections with one or more members and/or organizations of the online service. The connections may be defined as a social graph, where the member and/or organization is represented by a vertex in the social graph and the edges identify connections between vertices. In this regard, the edges may be bilateral (e.g., two members and/or organizations have agreed to form a connection); unilateral (e.g., one member has agreed to form a connection with another member), or combinations thereof. In this manner, members are said to be first-degree connections where a single edge connects the vertices representing the members; otherwise, members are said to be “nth”-degree connections where “n” is defined as the number of edges separating two vertices. As an example, two members are said to be “2nd-degree” connections where each member shares a connection in common with the other member, but the members are not directly connected to one another. In one embodiment, the social graph maintained by the online architecture 112 is stored in the social graph database 118.

Although the foregoing discussion refers to “social graph” in the singular, one of ordinary skill in the art will recognize that the social graph database 118 may be configured to store multiple social graphs. For example, and without limitation, the online architecture 112 may maintain multiple social graphs, where each social graph corresponds to various geographic regions; industries, members, or combinations thereof.

As members interact with the online service provided by the online architecture 112, the online architecture 112 is configured to monitor these interactions. Examples of interactions include, but are not limited to, commenting on content posted by other members, viewing member profiles, editing or viewing a member's own profile, sharing content outside of the online service (e.g., an article provided by an entity other than the online architecture 112), updating a current status, posting content for other members to view and/or comment on, and other such interactions. In one embodiment, these interactions are stored in a member activity database 116, which associates interactions made by a member with his or her member profile stored in the member profile database 120.

The online service may further include an event record database 122 that stores records of event records from interactions of the members of the online service. In one embodiment, the event record database 122 stores an event record for predetermined or configured interactions performed by members of the online service and/or performed by one or more platforms implemented by the online architecture 112. The event records may correspond to particular interactions by the members of the online service including, but not limited, an event record corresponding to an initial electronic message sent by a member of the online service, an event record corresponding to a reply to the initial electronic message by another member (e.g., the recipient), an event record corresponding to an indication that the recipient of the initial electronic message has not replied, and other such event records or combinations thereof. Each of the event records may corresponding to a particular event record type signifying the interaction or activity performed, or not performed, by the member of the online service. In one embodiment, an event record type is associated with a unique identifier that identifies the event record type and is interpretable by one or more platforms of the online architecture.

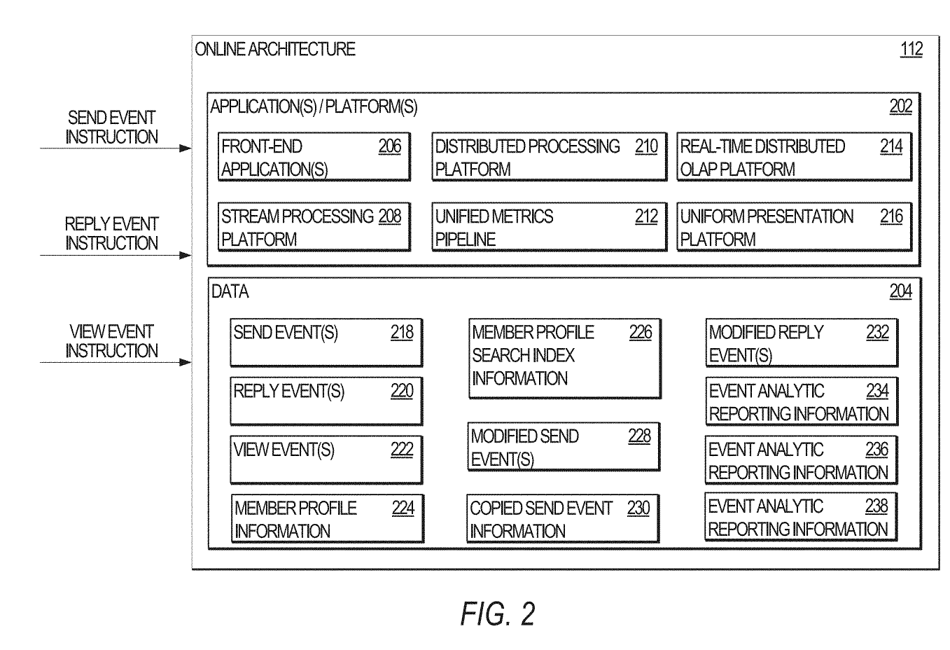

An event record may include various types of information associated with one or more members of the online service. In one embodiment, each event record type is associated with the member information that is to be included in the event record. The member information populated into the event record may be obtained from a variety of data sources of the online architecture 112. Examples of such data sources include the member activity database 116, the social graph database 118, the member profile database 120, and a search index (not shown) that associates one or more keywords, terms, and/or phrases with each member of the online service. The member profile search index information is further discussed below with reference to FIG. 2.

In one embodiment, the online architecture 112 communicates with the various databases 116-122 through one or more database server(s) 124. In this regard, the database server(s) 124 provide one or more interfaces and/or services for providing content to, modifying content in, removing content from, or otherwise interacting with, the databases 116-122. For example, and without limitation, such interfaces and/or services may include one or more Application Programming Interfaces (APIs), one or more services provided via a Service-Oriented Architecture (SOA), one or more services provided via a REST-Oriented Architecture (ROA), or combinations thereof. In an alternative embodiment, the online architecture 112 communicates with the databases 116422 and includes a database client, engine, and/or module, for providing data to, modifying data stored within, and/or retrieving data from, the one or more databases 116-122.

While the database server(s) 124 is illustrated as a single block, one of ordinary skill in the art will recognize that the database server(s) 124 may include one or more such servers. For example, the database server(s) 124 may include, but are not limited to, a Microsoft® Exchange Server, a Microsoft® Sharepoint® Server, a Lightweight Directory Access Protocol (LDAP) server, a MySQL database server, or any other server configured to provide access to one or more of the databases 116-124, or combinations thereof. Accordingly, and in one embodiment, the database server(s) 124 implemented by the online service are further configured to communicate with the online architecture 112.

FIG. 2 illustrates the online architecture 112 of FIG. 1, in accordance with an example embodiment. In one embodiment, the online architecture 112 includes various applications and/or platforms 206-216 for generating and/or modifying event records associated with member interactions of the online service. In addition, the applications and/or platforms 206-216 include an analytics and reporting platform that generates various metrics about the generated and/or modified vents, and is configured to output one or more graphical user interfaces that provide a graphical interpretation of the generated metrics. The graphical user interfaces facilitate human/machine interactions and allow a member of the online service to better understand the electronic messages that he or she is sending to various recipients, including metrics about interactions that the recipients may engage with the received electronic messages.

The various functional components of the online architecture 112 may reside on a single device or may be distributed across several computers in various arrangements. The various components of the online architecture 112 may, furthermore, access one or more databases (e.g., databases 116422 or any of data 204), and each of the various components of the online architecture 112 may be in communication with one another. Further, while the components of FIG. 2 are discussed in the singular sense, it will be appreciated that in other embodiments multiple instances of the components may be employed.

The online architecture 112 may also include one or more processors (not shown) that execute or implement one or more of the application(s)/platform(s) 202. The one or more processors may be any type of commercially available processor, such as processors available from the Intel Corporation, Advanced Micro Devices, Texas Instruments, or other such processors. Further still, the one or more processors may include one or more special-purpose processors, such as a Field-Programmable Gate Array (FPGA) or an Application Specific Integrated Circuit (ASIC). The one or more processors may also include programmable logic or circuitry that is temporarily configured by software to perform certain operations. Thus, once configured by such software, the one or more processors become specific machines (or specific components of a machine) uniquely tailored to perform the configured functions and are no longer general-purpose processors.

The online architecture 112 may further include various storage device(s) and/or machine-readable medium(s) for storing the application(s)/platform(s) 202 and/or the data 204. The machine-readable medium includes one or more devices configured to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store the application(s)/platform(s) 202 and the data 204. Accordingly, the machine-readable medium may be implemented as a single storage apparatus or device, or, alternatively and/or additionally, as “cloud-based” storage systems or storage networks that include multiple storage apparatus or devices.

In one embodiment, the application(s)/platform(s) 202 are written in a computer-programming and/or scripting language. Examples of such languages include, but are not limited to, C, C++, C#, Java, JavaScript, Perl, Python, or any other computer programming and/or scripting language now known or later developed.

With reference to FIG. 2, the application(s)/platform(s) 202 of the online architecture 112 are designed to generate and/or modify event records associated with electronic messages that members of the online service communicate to one another. The application(s)/platform(s) 202 are also configured to derive metrics about the electronic messages based on the event records, and to present one or more graphical user interfaces that graphically convey information about the derived metrics. To perform these and other operations in furtherance of these results, the application(s)/platform(s) 202 include, but are not limited to, one or more front-end application(s) 206, a stream processing platform 208, a distributed processing platform 210, a unified metrics pipeline 212, a real-time distributed Online Analytical Processing (OLAP) platform 214, and a uniform presentation platform 216. While the online architecture 112 may include alternative and/or additional applications (e.g., a networking application, a printing application, a software-implemented keyboard, etc.), such alternative and/or additional applications are not germane to this disclosure and the discussion of such is hereby omitted for brevity and readability.

The data 204 referenced and used by the application(s)/platform(s) 202 include various types of data in support of monitoring and/or modifying the event records associated with one or more of the electronic messages, and data in support of deriving metrics about the monitored and/or modified event records. In this regard, the data 204 includes, but is not limited to, one or more SEND event record(s) 218, one or more REPLY event record(s) 220, one or more VIEW event record(s) 222, and member profile information 224 obtained from one or more of the databases 116-122.

The data 204 may also include member profile search index information 226 that includes one or more keyword(s) that describe, and/or are associated with, a particular member (e.g., the sender of the electronic message or the recipient of the electronic message). In one embodiment, the online architecture 112 maintains a member profile search index with the one or more keywords associated with the one or more members, and one or more of the application(s)/platform(s) 202 access the member profile search index to obtain the member profile search index information 226. The member profile search index information 226 may be time-sensitive in that the member profile search index information 226 may change with some regularity and/or frequency. For example, one member may be associated with the keywords “TENURE” and/or “RECRUITING_ACTIVITY,” and these keywords may change or be removed from their associated with the particular member at a later date.

The data 204 also includes one or more modified SEND event record(s) 228, copied SEND event record information 230, and one or more modified REPLY event record(s) 232. The data 204 may further include event record analytic reporting information 234 associated with one or more of the SEND event record(s) 218, event record analytic information 236 associated with one or more of the REPLY event record(s) 220, and event record analytic information 238 associated with one or more of the VIEW event record(s) 222. The event record analytic reporting information 234-238 may be determined by the real-time distributed OLAP platform 214 and presented by the uniform presentation platform 216.

The front-end application(s) 206 are configured to present one or more web pages to the client device 104 for interacting with the online architecture 112. In one embodiment, the front-end application(s) 206 may provide a communication portal for a first member of the online architecture 112 to send one or more electronic messages to other members of the online architecture 112. For example, the front-end application(s) 206 may provide one or more webmail interfaces for the first member to send these electronic messages. As known to one of ordinary skill in the art, webmail generally refers to an email system in which a user can access their emails via a web browser on any computer or device that is connected to the Internet. Additionally and/or alternatively, the front-end application(s) 206 may implement one or more interfaces for stand-alone applications being executed by the client device 104 for the first member to send and/or receive electronic messages to other members of the online architecture 112. Thus, rather than using a web browser to interact with the online architecture 112, this member may use the stand-alone applications.

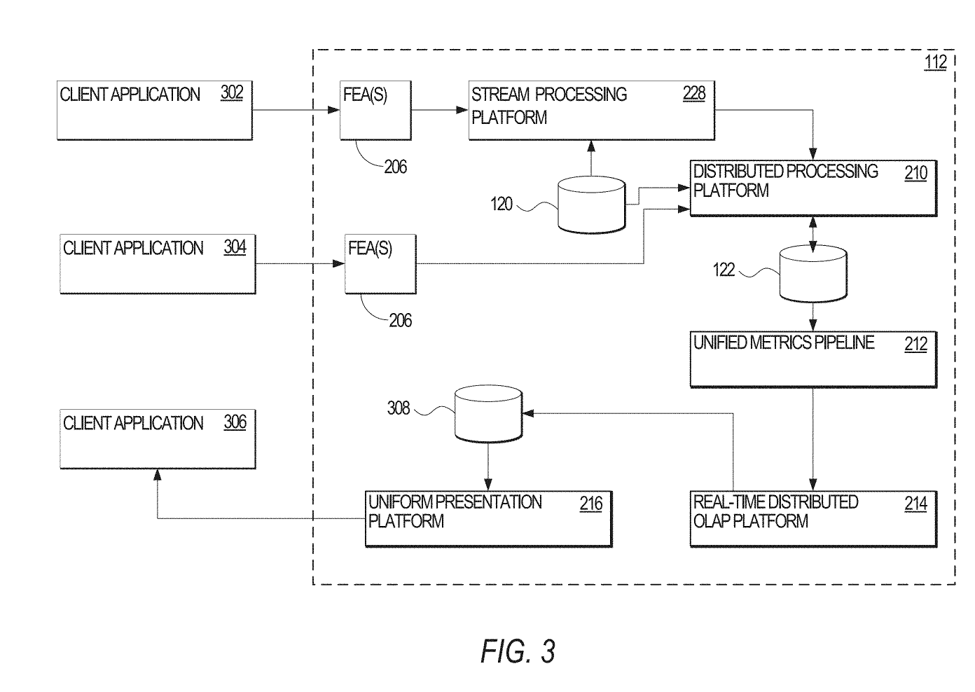

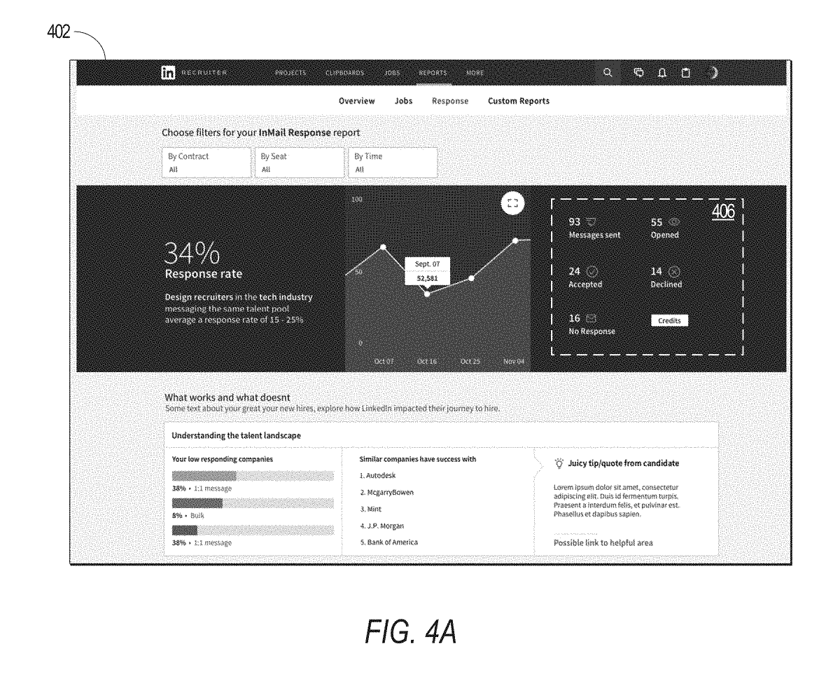

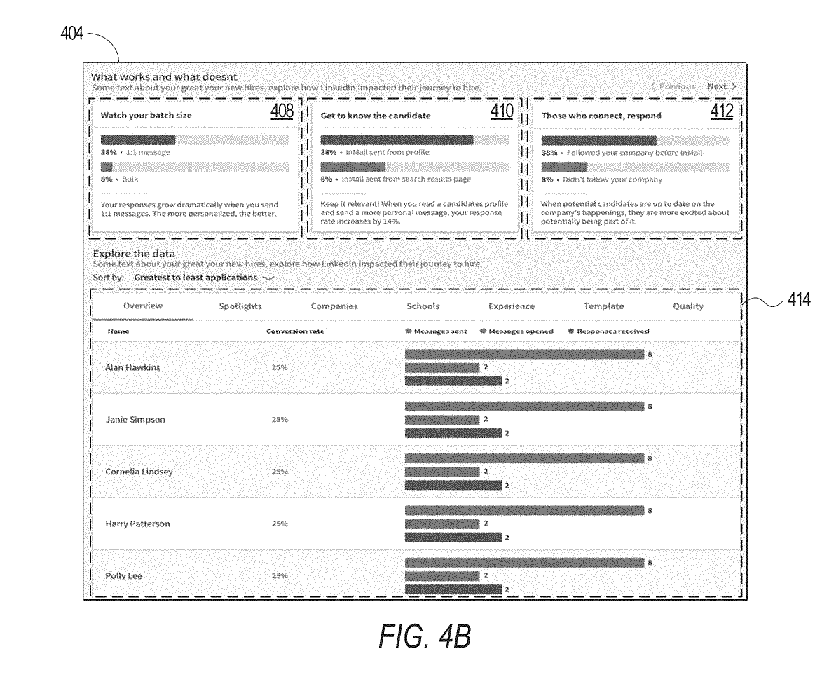

Referring to FIG. 3 is an illustration of a processing diagram, in accordance with an example embodiment, of the various application(s)/platform(s) 202, shown in FIG. 2, for processing event records associated with one or more electronic communications. As shown in FIG. 3, client applications 302-304 communicate with the front-end application(s) 206. In one scenario, a member of the online service may be using the client application 302 to send an electronic message to another member. In another scenario, a second member of the online service may be using the client application 304 to view and/or reply to one or more received electronic messages. As further discussed with reference to FIGS. 4A-4B, a third member may be using the client application 306 to view metrics or other analytics about one or more electronic messages previously sent to other recipients, which case, the application 306 may communicate with the uniform presentation platform 216.

Referring back to FIG. 2, and as discussed above, interactions with the online architecture 112 may result in the creation of one or more event records, where each event record is associated with a particular event record type that describes the type of interaction. In one embodiment, sending an electronic message to one or more recipients results in the creation of a SEND event record 218. The front-end application(s) 206 may be configured to generate the SEND event record 218 at the time the member the sender) sends the electronic message to the one or more recipients. In one embodiment; a SEND event record is associated with each recipient of the electronic message; thus, where there are 50 recipients of a single electronic message, the front-end application(s) 206 generate 50 SEND event record(s) 218.

In one embodiment, each SEND event record 218 may include information unique and/or particular to the sender and/or recipient of the electronic message. One example of a SEND event record is listed below:

```
{
....
  “activity” : {
  “recipientMemberUrn” : “urn:li:member:4567890”,
  “senderMemberUrn” : “urn:li:member:1234567”,
  “senderSeatUrn” : “urn:li:seat:77122603”,
  “contractUrn” : “urn:li:contract:93960”,
  “companyUrn” : null,
  “parentContractUrn” : “urn:li:contract:93960”,
  “mailboxItemUrn” : “urn:li:mail:S6170016637039710208_500”,
  “customPropertyUrn” : “urn:li:customProperty:2513281243-
112230-1927454”,
  “messageChannelType” : “INMAIL”,
  “messageBodyWordCount” : 75,
  “messageBodyCharacterCount” : 451,
  “numberOfRecipients” : 1,
  “inmailTemplateUrn” : {
    “string” : “urn:li:inmailTemplate:507741543”
  }
  }
}
```

In the foregoing example, the SEND event record 218 is implemented as a record, where the record comprises one or more event record fields, and each event record field has a corresponding value. The event record field values may be a series of alphanumeric characters (e.g., a “String,”), a series of one or more numbers (e.g., an “Integer”), a TRUE or FALSE value, (e.g., a “Boolean”), or other such data type. In the foregoing example, event record fields provide information about the sender of the electronic message and information about the recipient of the electronic message. In this case, the sender of the electronic message is associated with a member identification number of “1234567” and the recipient of the electronic message is associated with a member identification number of “4567890”. In this regard, each member of the online service may be associated with a unique member identification number, and the application(s)/platform(s) 202 of the online architecture 112 are configured to associate event records (e.g., SEND event record(s) 218, REPLY event record(s) 220, and VIEW event record(s) 222) with members of the online service using this member identification number. In one embodiment, the front-end application(s) 206 may be configured to populate these event record fields by communicating with one or more of the database server(s) 124 and querying the member profile database 120 for such values.

The SEND event record 218 also includes information about the type of interaction engaged in by the sender of the electronic message. For example the SEND event record 218 indicates that the sender used a particular channel of communication, “InMail,” for communicating with the recipient, and that the electronic message included 75 words in approximately 451 characters in length. In one embodiment, the online architecture 112 may include more than one channel of communication for members to communicate, and the front-end application(s) 206 are configured to populate the event record field associated with the channel of communication with a value corresponding to the channel of communication used by the sender of the electronic message. To generate the event record field values associated with the characteristics of the message, the one or more front-end application(s) 206 may be configured to count the words and/or characters as the sender of the electronic message is typing them or after the sender has instructed the front-end application(s) 206 to send the electronic message. Such word counting tool or other module may be implemented as a script (e.g., via JavaScript) at the time the client device 104 loads the webmail interface provided by the front-end application(s) 206.

However, at the time the SEND event record 218 is generated, the front-end application(s) 206 may not have access to time-sensitive or real-time information about the sender and/or recipient. Accordingly, in one embodiment, after the front-end application(s) 206 has generated the SEND event record 218, the SEND event record 218 is then communicated to the stream processing platform 208. As shown in FIG. 3, the stream processing platform 228 is in communication with the front-end application(s) 206 and the distributed processing platform 210. In addition, the stream processing platform 228 is in communication with one or more databases, such as the member profile database 120 and/or a member profile search index. The stream processing platform 208 may communicate with the member profile search index by sending one or more member identifiers to the member profile search index and, in return, receive one or more search keywords associated with the member corresponding to the member identifier. Referring back to FIG. 2, the stream processing platform 208 may store the one or more search keywords as the member profile search index information 226.

In addition, the stream processing platform 208 is configured to modify the SEND event record 218 by adding (e.g., appending) additional event record fields to the SEND event record 218 along with corresponding values for the event record fields. An example of a modified SEND event record is below, which is based on the example SEND event record shown above:

```
{
...
“activity” : {
  “recipientMemberUrn” : “urn:li:member:4567890”,
  “senderMemberUrn” : “urn:li:member:1234567”,
  “senderSeatUrn” : “urn:li:seat:77122603”,
  “contractUrn” : “urn:li:contract:93960”,
  “companyUrn” : null,
  “parentContractUrn” : “urn:li:contract:93960”,
  “mailboxItemUrn” : “urn:li:mail:S6170016637039710208_500”,
  “customPropertyUrn” : “urn:li:customProperty:2513281243-
112230-1927454”,
  “messageChannelType” : “INMAIL”,
  “messageBodyWordCount” : 75,
  “messageBodyCharacterCount” : 451,
  “numberOfRecipients” : 1,
  “inmailTemplateUrn” : {
    “string” : “urn:li:inmailTemplate:507741543”
  },
  “recipientSpotlights”:[“TENURE”,“RECRUITING_ACTIVITY” ]
  }
}
```

In the example shown above, the stream processing platform 228 has appended an additional field to the previously generated SEND event record 218, namely, a “recipientSpotlights” event record field. The stream processing platform 228 has further written event record field values into the added event record field, namely, the event record field values of “TENURE” and “RECRUITING_ACTIVITY,” both of which are keywords associated with the recipient of the electronic message corresponding to the generated SEND event record 218. In one embodiment, the stream processing platform 228 obtains the event record field values that it writes from one or more databases, such as the member profile database 120. As shown in FIG. 3, the stream processing platform 228 may be in communication with the front-end application(s) 206, the member profile database 120, and the distributed processing platform 210.

Referring back to FIG. 2, the stream processing platform 228 may additionally and/or alternatively, obtain the event record field values to modify the SEND event record 218 from a member profile search index. As mentioned previously, the member profile search index comprises associations between one or more keywords, terms, and/or phrases and members of the online service. The keywords stored by the member profile search index may be subject to frequent changes relative to the information stored in the one or more databases 116-122. For example, the associations between keywords and members stored by the member profile search index may change on an hourly basis and/or in substantially in real-time. One example of the member profile search index is the Galene search architecture, which is described in the non-patent literature document Sankar, Sriram, “Did you mean Galene?” (Jun. 5, 2010, the disclosure of which is hereby incorporated by reference in its entirety. In one embodiment; the event record fields and/or event record field values to be added into the SEND event record 218 are stored as the member profile search index information 226. Thus, the “recentSpotlights” event record field and the event record field values of “TENURE,” and “RECRUITING_ACTIVITY” may be stored as the member profile search index information 226.

After initially modifying the SEND event record 218, the stream processing platform 208 communicates the modified SEND event record to the distributed processing platform 210. As shown in FIG. 3, the distributed processing platform 210 is in communication with the stream processing platform 208, the member profile database 120, the front-end application(s) 206, and the event record database 122.

Referring back to FIG. 2, and in one embodiment, the distributed processing platform 210 is configured to further modify the SEND event record 218 by appending and/or adding additional member profile information to the modified SEND event record 210. Accordingly, the SEND event record 218 that was modified by the stream processing platform 208 is further modified by the distributed processing platform 210. In one embodiment, this further modified SEND event record 218 is stored as the modified. SEND event record(s) 228. One example of a modified SEND event record 228 is provided below. The below example is based on the prior two examples of the SEND event record 218 initially generated by the front-end application(s) 206.

```
{
        “timestamp” : 1470120741753,
        “contractId” : 216763796,
        “seatId” : 120461336,
        “recipientMemberId” : 4567890,
        “customPropertyUrn” : “urn:li:customProperty:2148065416-
      51387-14124196”,
        “messageType” : “REACH_OUT_ATTEMPT”,
        “messageEvent recordSourceType” : “PROFILE”,
        “messageChannelType” : “INMAIL”,
        “replyType” : “PENDING”,
        “messageCharCountRange” : “SMALL”,
        “messageNumRecipientsRange” : “SINGLE”,
        “messageInmailTemplateId” : null,
        “isProfileViewed” : true,
        “recipientCompanyId” : {
        “long” : 2707435
        },
        “recipientSchoolId” : {
        “long” : 18484
        },
        “recipientSpotlights” : [“TENURE”,
      “RECRUITING_ACTIVITY” ],
        “recipientLocationRegionCode” : {
        “int” : 4910
        },
        “recipientLocationCountryCode” : {
        “string” : “au”
        },
        “recipientYearsOfExperience” : 4,
        “recipientIndustryId” : {
        “long” : 42
        },
        “sendTimeHoursSinceEpoch” : 408366,
        “sendTimeDaysSinceEpoch” : 17015,
        “sendTimeWeeksSinceEpoch” : 2430,
        “sendTimeMonthsSinceEpoch” : 559,
        “replyTimeHoursSinceEpoch” : 0,
        “replyTimeDaysSinceEpoch” : 0,
        “replyTimeWeeksSinceEpoch” : 0,
        “replyTimeMonthsSinceEpoch” : 0,
        “numberOfMessagesSent” : 1,
        “numberOfMessagesReplied” : 0
}
```

To modify the SEND event record previously modified by the stream processing platform 208, the distributed processing platform 210 may be in communication with one or more databases 116-122. For example, the distributed processing platform 210 may query the member profile database 120 with the member identifier of the recipient of the electronic message corresponding to the SEND event record, and populate the SEND event record with one or more event record fields and/or event record field values corresponding to the member profile information stored in the member profile database 120. In one embodiment, the distributed processing platform 210 queries the member profile database 210 for the member profile information of the recipient and/or sender of the electronic message, and this information is stored as the member profile information 224.

The distributed processing platform 210 modifies the SEND event record 218 by adding and/or appending event record fields corresponding to one or more member profile attributes of the member profile information 224. In one embodiment, the distributed processing platform 210 adds event record fields according to the event record type associated with the event record. Thus, the event record fields added by the distributed processing platform 210 may be different depending on whether the event record being modified is a SEND event record, a REPLY event record, or a VIEW event record. To modify a given event record with one or more event record fields, the online architecture 112 may maintain a rules engine with one or more rules, a two-dimensional table, an array, or other logical construct that associates member profile attributes of the member profile information 224 with event record fields to be added to a given event record. In this manner, the stream processing platform 208 and/or the distributed processing platform 210 modify a given event record by querying the logical construct with the event type of the event record being modified to obtain the member profile attributes and/or values that are to be added into the event record.

After modifying the SEND event records 210 to obtain the modified SEND event record(s) 228, the distributed processing platform 210 may then store the modified SEND event record(s) 228 into the event record database 122. In storing the modified SEND event record(s) 228, the distributed processing platform 210 may establish and/or create associations between the modified SEND event record(s) 228 and each of the recipients of the electronic message corresponding to the modified SEND event record(s) 228. In this way, the recipients of electronic messages may be associated with corresponding modified SEND event record(s) 228, which are distinct from the electronic message communicated to the recipient. Furthermore, one or more other application(s)/platform(s) 202 of the online architecture 112, such as the real-time distributed OLAP platform 214, may then retrieve the modified SEND event record(s) 228 to generate various metrics from them.

The member profile information 224 added by the distributed processing platform 210 and the member profile search index information 226 added by the stream processing platform 208 may be different types of information. The information added by these platforms may be different in how frequent such information changes. The member profile search index information 226 may change on a daily, hourly, or near real-time basis. In contrast, the member profile information 224 may change less frequently (e.g., infrequently), such as on a daily, weekly, or monthly basis. Furthermore, the amount of member profile search index information 226 added to a given event may be less than the amount of information added for the member profile information 224. As shown above, the resulting modified SEND event record 228 includes more event record fields corresponding to member profile attributes of the member profile information 224 than event record fields corresponding to the member profile search index information 226. Thus, the stream processing platform 208 is implemented to handle more lightweight and more frequent changes to stored information, whereas the distributed processing platform 210 is implemented to handle more heavyweight information and information less subject to change.

Although the foregoing examples refer to an event record of a SEND event type, the stream processing platform 208 and the distributed processing platform 210 are also configured to modify event records associated with other event types, such as REPLY event record(s) 220 and VIEW event record(s) 222. Used in this context, a REPLY event record 220 is an event record associated with an electronic message being sent in reply to an electronic message having been received, where the received electronic message is associated with a SEND event record. Similarly, a VIEW event record 222 is an event record associated with an interaction with the online architecture 112 where the recipient of an electronic message associated with a SEND event record has viewed the electronic message. Thus, in some circumstances, two event records may be generated by the front-end application(s) 206 when a recipient receives an electronic message associated with a SEND event record 218: a first VIEW event record 222 indicating that the recipient has viewed the electronic message and a second REPLY event record 220 should the recipient reply to the electronic message.

FIG. 3 illustrates an example of a process flow where the event record being generated is a REPLY event record or a VIEW event record. The process flow begins at client application 304, where the client application 304 interacts with the front-end application(s) 206 to view or reply to a received electronic message (e.g., where the member is a recipient). At the frond-end application(s) 206, a new event record is generated and assigned a REPLY event record type or a VIEW event record type, depending on the interaction with the received electronic message. An example of a REPLY event record generated by the front-end application(s) 206 is listed below:

```
{
...
  “activity” : {
    “senderMemberUrn” : “urn:li:member:123456”,
    “recipientMemberUrn” : “urn:li:member:567890”,
    “recipientSeatUrn” : “urn:li:seat:37761101”,
    “contractUrn” : “urn:li:contract:291630”,
    “customPropertyUrn”
“urn:li:customProperty:2511533223-16916420-73469”,
    “messageChannelType” : “INMAIL”,
    “replyType” : “ACCEPTED”,
    “repliedMailboxItemUrn” : {
      “string” : “urn:li:mail:16169749500995870720_500”
    }
    }
}
```

The event record fields of the generated REPLY event record may include one or more member profile attributes, such as the member identifier of the sender (e.g., “123456” for the above example) and/or the member identifier of the recipient (e.g., “567890” for the above example). The front-end application(s) 206 may also generate a similar VIEW event record, where the VIEW event record includes alternative event record fields to the event record fields present in the REPLY event record.

Thereafter, the process flow of the VIEW event record or the REPLY event record proceeds to the distributed processing platform 210. Process flow proceeds to the distributed processing platform 210 because the distributed processing platform 210 is configured to modify the VIEW event record or the REPLY event record with the event record information of the SEND event record from the initially received electronic message. In one embodiment, the distributed processing platform 210 is configured to copy one or more event record fields and values of the SEND event record, and to populate the corresponding VIEW event record and/or REPLY event record with the copied event record fields and values. The copied SENT event record fields and/or values may be stored as the copied SEND event record information 230. Referring to the SEND event record fields of the example of the modified SEND event record above, below is an example of a modified REPLY event record having:

```
{
  “timestamp” : 1471154582390,
  “contractId” : 218831846,
  “seatId” : 122040026,
  “recipientMemberId” : 567890,
  “customPropertyUrn” : “urn:li:customProperty:2175594846-
155692199270909774”,
  “messageType” : “REPLY_FROM_PROSPECT”,
  “messageEventSourceType” : “PROFILE”,
  “messageChannelType” : “INMAIL”,
  “replyType” : “ACCEPTED”,
  “messageCharCountRange” : “SMALL”,
  “messageNumRecipientsRange” : “SINGLE”,
  “messageInmailTemplateId” : null,
  “isProfileViewed” : true,
  “recipientCompanyId” : {
    “long” : 35804
  },
  “recipientSchoolId” : {
    “long” : 13919
  },
  “recipientSpotlights”: [“TENURE”,
“RECRUITING_ACTIVITY” ],
  “recipientLocationRegionCode” : {
    “int” : 84
  },
  “recipientLocationCountryCode” : {
    “string” : “us”
  },
  “recipientYearsOfExperience” : 1,
  “recipientIndustryId” : {
    “long” : 57
  },
  “sendTimeHoursSinceEpoch” : 408653,
  “sendTimeDaysSinceEpoch” : 17027,
  “sendTimeWeeksSinceEpoch” : 2432,
  “sendTimeMonthsSinceEpoch” : 559,
  “replyTimeHoursSinceEpoch” : 408654,
  “replyTimeDaysSinceEpoch” : 17027,
  “replyTimeWeeksSinceEpoch” : 2432,
  “replyTimeMonthsSinceEpoch” : 559,
  “numberOfMessagesSent” : 1,
  “numberOfMessagesReplied” : 1
}
```

In the foregoing example, the distributed processing platform 210 copies one or more SEND event record fields and/or values into the REPLY event record, thus creating one or more modified REPLY event record(s) 232. The SEND event record fields that are copied into the REPLY event record may include those event record fields and/or values generated by the stream processing platform 208 and/or the event record fields and/or values generated by the distributed processing platform 210. As a reply to an electronic message may not happen for a non-trivial time period, e.g., days or weeks, the distributed processing platform 210 is configured to process the resulting REPLY event record and/or VIEW event record at periodic intervals. Thus, the distributed processing platform 210 may maintain a queue of one or more REPLY event records and/or VIEW event records waiting to be modified.

With reference to FIG. 3, the distributed processing platform 210 may then store the modified REPLY event record(s) 232 into the event record database 122. Although not shown in a foregoing example, the distributed processing platform 210 may modify VIEW event records similarly.

The distributed processing platform 210 is configured to modify the initially generated REPLY event record(s) 220 and/or VIEW event record(s) 222 to generate meaningful metrics for later review by the initial sender of the electronic message (e.g., the sender that initiated the conversation with the recipient of the electronic message). The following scenario illustrates one example why the distributed processing platform 210 modifies the REPLY or VIEW event record by copying one or more event record fields from the corresponding SEND event record:
Member Q sends a message to 100 members who work at Company ABC. The online architecture 112 accounts the corresponding send event records for Company ABC. All 100 members then move from Company ABC to Company DEF and Company GHI. The members from Company DEF and Company GHI then reply to Member Q. Now if the online architecture 112 uses the current company data for the reply event records when determining the response rates, Company ABC will be associated with a zero response rate, while Company DEF and Company GHI will be associated with divide-by-zero reply rates (e.g., assuming there are no SEND event records associated with Company DEF or Company GHI).

In the foregoing example, the generation and storing of the various event records allow the online architecture 112 to derive meaningful metrics about electronic messages communicated among members of the online service. Otherwise, such metrics may be meaningless or nonsensical, as in the case where a divide-by-zero error occurs.

To generate and present meaningful metrics about the event records stored in the event record database 122, the application(s)/platform(s) 202 of the online architecture include a unified metrics pipeline 212, a real-time distributed OLAP platform 214, and a uniform presentation platform 216. FIG. 3 illustrates one example of the process flow of the platforms 212-216 in determining the metrics from the event records stored in the event record database 122, 3 further illustrates an analytic reporting information database 308, which may store event analytic reporting information determined by the real-time distributed OLAP platform 214. Referring briefly to FIG. 2, the event analytic reporting information may include SEND event analytic reporting information 234, REPLY event analytic information 236, and VIEW event analytic reporting information 238. The different types of metrics and analytics determined by the real-time distributed OLAP platform 214 are discussed below with references to FIGS. 4A-4B.

The unified metrics pipeline 212 is configured to ingest one or more of the event records from the event records database 122. In one embodiment, the unified metrics pipeline 212 is implemented as software-as-a-service (SaaS), and one or more of the other platforms, such as the real-time distributed OLAP platform 214 and/or the uniform presentation platform 216 may submit requests and/or messages to the unified metrics pipeline 212 to obtain statistics and/or values associated with the event records stored in the event record database 122.

The real-time distributed OLAP platform 214 is configured to determine metrics based on the event records stored in the event record database 122. One example of the real-time distributed OLAP platform 214 is disclosed in the non-patent literature reference, Naga, Praveen Neppalli, “Real-Time Analytics at Massive Scale with Pinot,” LinkedIn® Engineering, Sep. 29, 2014, the disclosure of which is hereby incorporated by reference in its entirety. The real-time distributed OLAP platform 214 is configured to determine metrics about electronic messages communicated among members of the online service and, in some instances, to determine metrics about the electronic messages for a given member. The real-time distributed OLAP platform 214 may be configured to determine a preconfigured set of metrics, such as response rates, messages sent, messages received, the types of members most likely to respond, the types of members least likely to respond, an overall response rate for a given industry, response rates for one or more organizations (e.g., non-profit organizations, for-profit organizations, government organizations, etc.), and other such metrics or combination of metrics.

Furthermore, the real-time distributed OLAP platform 214 may determine such metrics for predetermined time periods and/or ranges, including hourly metrics, daily metrics, weekly metrics, monthly metrics, or selectable time ranges and/or date ranges. In addition, the real-time distributed OLAP platform 214 may be configured to determine such metrics on a real-time or near real-time basis. For example, the real-time distributed OLAP platform 214 may determine such metrics as new event records are added to the event record database 122 and/or when a member requests metrics regarding his or her electronic messages. Referring briefly to FIG. 2, the analytic reporting information 234-238 comprise the metrics determined by the real-time distributed OLAP platform 214, which may store such information in the analytic reporting information database 308.

To determine the metrics from the various electronic messages, the real-time distributed OLAP platform 214 may reference one or more event record fields for one or more event record types. For example, the real-time distributed OLAP platform 214 may reference one or more member identifier fields of SEND event records, REPLY event records, and/or VI 1-W event records to determine which members are associated with which event records. As another example, the real-time distributed OLAP platform 214 may reference an organization field (e.g., the “recipientCompanyID” event record field) of the various types of event records to determine which organizations are likely to have members that respond to electronic messages. As yet a further example, the real-time distributed OLAP platform 214 may reference the keyword search field (e.g., the “recipientSpotlights” event record field) to determine metrics that indicate which types of members are likely to respond to electronic messages sent by other members. In this way, the real-time distributed OLAP platform 214 is configured to determine metrics about the electronic messages communicated among members of the online service, and to store such metrics until a time when members of the online service request to view such metrics.

To view the metrics determined by the real-time distributed. OLAP platform 214, the online architecture 112 is further configured with a uniform presentation platform 216. One example of a uniform presentation platform 216 is disclosed in the non-patent literature reference, Clatterbuck, Sarah, “Pemberly at LinkedIn,” Linkedin® Engineering, Dec. 2, 2016, the entire disclosure of which is hereby incorporated by reference in its entirety. As shown in FIG. 3, the uniform presentation platform is in communication with the analytic reporting information database 308. Accordingly, and in one embodiment, the uniform presentation platform 216 is configured to provide consistent user experiences across different operating systems and regardless of the web browser, or other application, that a member of the online service may use to access and retrieve the analytic reporting information.

FIGS. 4A-4B illustrate graphical user interfaces 402-404, in accordance with example embodiments, displaying analytical information derived by the platforms illustrated in FIG. 2. In particular, the graphical user interfaces 402-404 are generated by the uniform presentation platform 216 where the presented analytical information has been derived by the real-time distributed OLAP platform 214.

With reference to FIG. 4A, the graphical user interface 402 displays various metrics particular to a member of the online service that has sent electronic messages associated with one or more SEND event record(s) 228. In one embodiment, the graphical user interface 402 is displayed as one or more webpages presented on a device being used by the member, such as client device 104, As shown in FIG. 4A, the graphical user interface 402 may include various metrics 406 about the member. These metrics 406 include, but are not limited to, the number of electronic messages sent (e.g., 93 messages sent), the number of connection requests accepted (e.g., 24 connection requests accepted), the number of electronic messages that have not been responded to (e.g., 16 non-responses), the number of electronic messages that were viewed (e.g., 55 opened messages), and the number of connection requests that were declined (e.g., 14 declined connection requests). Each of the metrics 406 may have been previously determined by the real-time distributed OLAP platform 214 and stored in the analytic reporting information database 308.

Using the graphical user interface 402, the member may also apply filters to one or more of the determined metrics. These filters include, but are not limited to, any contracts that the member may have with one or more organizations having registered with the online service, the seat holders associated with the member, one or more predetermined timeframes (e.g., today, yesterday, past week, past month, last two weeks, etc.), and any other such filters or combinations thereof.

Based on the metrics shown in the graphical user interface 402, a member can decide how to better communicate and/or engage with other members of the online service. Where a metric indicates that a particular type of member is more likely to respond to an electronic message, the member (e.g., the sender of the electronic message) may decide to more frequently target such members for additional electronic messages. Where a metric indicates that a particular type of electronic message has a lackluster response rate (e.g., a response rate less than a predetermined response rate threshold), the sender of the electronic message may decide to pursue alternative means of engagement or to change the subject matter of the electronic message. Thus, the graphical user interface 402 provides a mechanism for a sender of electronic messages to better understand the impact such electronic messages are having and how best to engage with other members of the online service.

The uniform presentation platform 216 is also configured to provide a device with one or more graphical user interfaces relating to a group or set of members registered with the online service. Referring next to FIG. 4B is a graphical user interface 404 illustrating metrics about multiple members of the online service in accordance with an example embodiment. As shown in FIG. 4B, the graphical user interface 404 includes various sections 408-414 that display metrics for a selected group of members of the online service relating to the electronic messages each of the members have sent to other members, A first section 408 displays metrics relating to electronic messages that were sent as bulk electronic messages (e.g., electronic messages where there was more than one recipient). A second section 410 displays metrics relating to the webpage from which an electronic message was sent, such as the member profile webpage for a selected member or a search result page having search results represented various members of the online service. A third section 412 includes metrics about interactions that members of the online service have engaged in, such the percentage of members that “follow” (e.g., establish a unidirectional relationship with) a member profile associated with an organization registered with the online service.

The graphical user interface 404 also includes a fourth section 414 that displays selected metrics about one or more members of the online service. As shown in FIG. 4B, the fourth section 414 includes metrics about the response rates for various electronic messages communicated by, and received by, selected members of the online service. In one embodiment, the fourth section 414 is generated by the uniform presentation platform 216 based on the analytic reporting information stored in the analytic reporting information database 308. For example, the analytic reporting information included in the fourth section 404 may include a first metric corresponding to a number of electronic messages sent, a second metric corresponding to a number of electronic messages that were viewed by recipients of electronic messages, and a third metric corresponding to the number of replies received in response to previously received electronic messages. As explained above, each of the foregoing metrics may be determined from one or more of the previously generated event records (e.g., from one or more SEND event records, one or more REPLY event records, and/or from one or more VIEW event records). The graphical user interface 404 may be provided as a webpage to the client device 104 or as screen within the client application(s) 108 and/or programmatic client 110. In this way, the uniform presentation platform 216 provides graphical user interfaces to the client device 104 for a member of the online service to readily view and/or interpret the metrics determined by the real-time distributed OLAP platform 214.

The graphical user interface 404 helps a member (e.g., a group leader or administrator) to better understand how a particular set of members (e.g., a group of senders of electronic messages) are engaging with other members of the online service. By viewing the metrics shown in the graphical user interface 404, the group leader or administrator can determine which members of the group of members are successfully interacting with other members of the online service and can share the decisions made by the successful member with other members of the group who may not be as successful. In this way, the graphical user interface 404 helps the group leader or administrator better manage a group

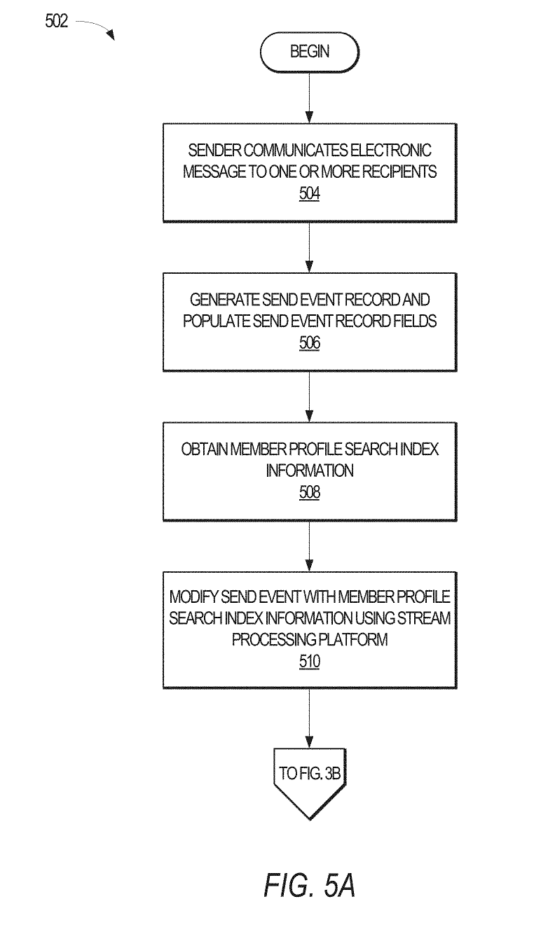

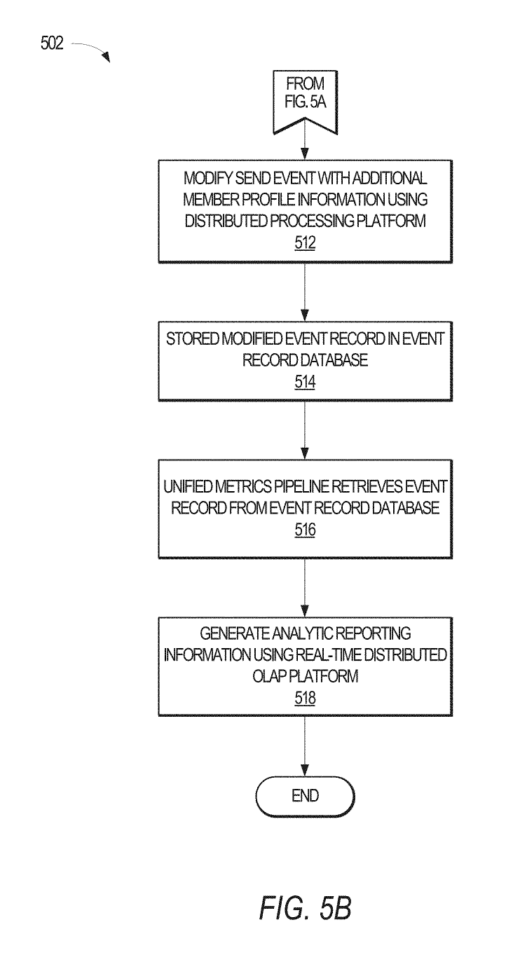

FIGS. 5A-5B illustrate a method 502, in accordance with an example embodiment, for modifying a SEND event record associated with a message sent by a message sender using the online architecture 112 of FIG. 1. The method 502 may be implemented by one or more of the application(s)/platform(s) 202 illustrated in FIG. 1 and is discussed by way of reference thereto.

Initially and with reference to FIG. 2, a member of the online service writes and/or communicates an electronic message to one or more recipients (Operation 504). In one embodiment, the one or more recipients of the electronic message are also members of the online service. Furthermore, the sender of the electronic message may use one or more front-end application(s) 206 to write and/or communicate the electronic message to the one or more recipients.

In response to the writing and/or sending of the electronic message, the front-end application(s) 206 generate one or more SEND event record(s) 218 (Operation 506). Furthermore, the front-end application(s) 206 may populate one or more SEND event record fields with values corresponding to member profile information of the sender and/or one or more recipients of the electronic message. For example, the front-end application(s) 206 may initially populate the SEND event record(s) 218 with the member identifier of the sender and/or the member identifier of the one or more recipients. In one embodiment, a single SEND event record is populated with the member identifiers of the one or more recipients. In another embodiment, multiple SEND event record(s) 218 are generated, where each SEND event record is populated with a different member identifier such that each SEND event record is unique and/or specific to a given recipient. As shown in the foregoing examples, the front-end application(s) 206 populate a SEND event record with additional event record fields and values.

The stream processing platform 208 then adds additional time-sensitive member information to the generated SEND event record. In one embodiment, the stream processing platform 208 obtains member profile search index information 226 from a member profile search index (Operation 508). The member profile search index information 226 may comprise one or more keywords associated with a particular member of the online service, such as the recipient of the electronic message. The stream processing platform 208 then modifies the SEND event record generated by the front-end application(s) 206 using the obtained member profile search index information 226 (Operation 510). As discussed previously, modifying the SEND event record with the member profile search index information 226 may comprise adding one or more event record fields to the SEND event record, along with corresponding values for the added event record fields.

Referring next to FIG. 5B, the distributed processing platform 210 then further modifies the SEND event record with member profile information 224 (Operation 512). In one embodiment, the SEND event record modified by the stream processing platform 208 is communicated to, or stored in, a queue of other event records to be modified by the distributed processing platform 210. As the member profile information added by the distributed processing platform 210 is not as volatile as the keywords added by the stream processing platform 208, the distributed processing platform 210 may operate on the event records at predetermined time intervals that occur at a time later than the processing performed by the stream processing platform 208. The distributed processing platform 210 then stores the modified SEND event record 228 into the event database 122, which may then be retrieved by other application(s)/platform(s) 202 of the online architecture 112, such as the real-time distributed OLAP platform 214 and/or unified metrics pipeline 212.

After the modified SEND event record 228 is stored in the event database 122, the unified metrics pipeline 212 then accesses and/or retrieves the modified SEND event record 228 (Operation 516). The unified metrics pipeline 212 may then communicate the modified SEND event record to the real-time distributed OLAP platform 214 for determining various metrics about the electronic messages associated with the modified SEND event record (Operation 518). As explained previously, the real-time distributed OLAP platform 214 may determine such metrics at predetermined intervals using one or more event record field values from the modified SEND event record. Such metrics may then be stored in the analytic reporting information database 308 for later retrieval and/or processing by the uniform presentation platform 216.

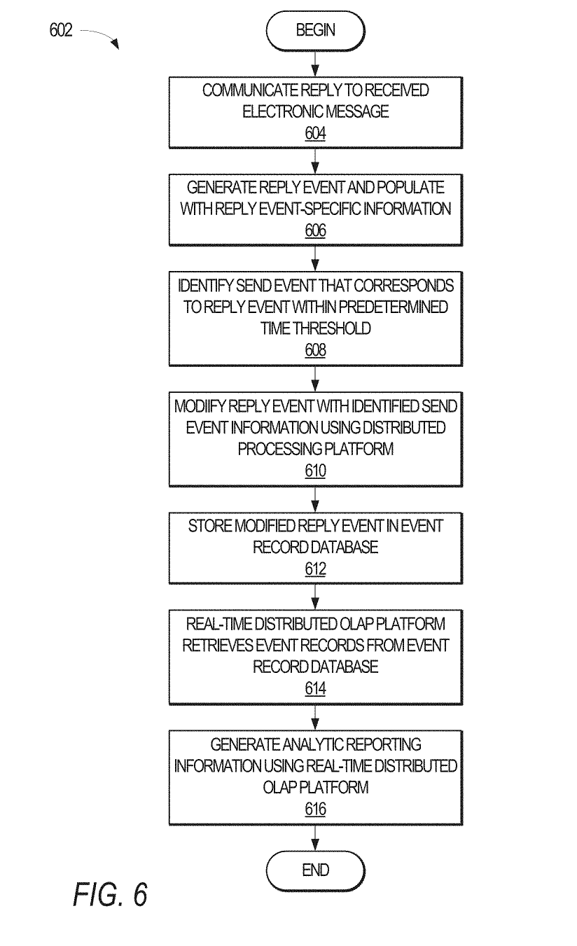

FIG. 6 illustrates a method 602, in accordance with an example embodiment, for modifying a REPLY event record associated with a message sent in reply to a message that was previously received. The method 602 may be implemented by one or more of the application(s)/platform(s) 202 illustrated in FIG. 2 and is discussed by way of reference thereto. Although the method 602 is described with reference to a REPLY event record, the method 602 may be applied to other event record types including, but not limited to, a VIEW event record.

Initially, a member of the online service replies to a received electronic message, where the received electronic message is associated with a corresponding SEND event record (Operation 604). In one embodiment, the member uses one or more of the front-end applications(s) 206 to compose and send the electronic message. Accordingly, the front-end application(s) 206 generate a REPLY event record corresponding to the electronic message being sent as a reply (Operation 606). The front-end application(s) 206 may then initially populate the REPLY event record with one or more event record fields and/or values for a REPLY event record. Examples of REPLY event record fields and/or values that the front-end application(s) 206 may populate include a member identifier for the initial sender of the electronic message, a member identifier for the recipient of the electronic message, the channel of communication being used to send the electronic message, and other such event record fields and/or fields. Further still, with regard to a REPLY event record, the value of the member identifier for the sender of the electronic message may be the value of the member identifier that initially sent the electronic message or the member identifier for the member that is replying to the electronic message. Similarly, the value of the member identifier for the recipient of the electronic message may be the value of the member identifier that initially sent the electronic message or the member identifier for the member that is replying to the electronic message.

Further processing of the REPLY event record that proceeds to the distributed processing platform 210. Initially, the distributed processing platform 210 may determine whether the REPLY event record has been generated within a predetermined time threshold, e.g., within a predetermined time period of the SEND event record having been created. In one embodiment, this predetermined time threshold may be 30 days. The online architecture 112 may establish this time threshold to filter out replies and/or to distinguish between replies that are considered “timely” and those replies that are considered “late” or “non-responsive.”

in one embodiment, the distributed processing platform 210 identifies the SEND event record corresponding to the REPLY event record where the REPLY event record is generated within the predetermined time threshold (Operation 608). Where the REPLY event record is generated within the predetermined time threshold, the distributed processing platform 210 may then modify the REPLY event record by copying one or more SEND event record fields and/or values into the REPLY event record (Operation 610). Where the REPLY event record is generated outside of the predetermined time threshold, the distributed processing platform 210 may populate the REPLY event record with a predetermined set of event record fields and/or values. A lookup table and/or rules engine may inform the distributed processing platform 210 as to the event record fields and/or values that are to be populated into the “late” or “non-responsive” REPLY event record, which may be different than the event record fields and/or values copied from the SEND event record.

Having modified the REPLY event record, the distributed processing platform 210 may then store the modified. REPLY event record in the event record database 122 (Operation 612). Accordingly, the real-time distributed OLAP platform 214 then accesses to the event record database 122 to retrieve and/or access one or more of the event records (Operation 614). Thereafter, the real-time distributed OLAP platform 214 determines analytic reporting information (e.g., one or more metrics) using the modified REPLY event record (Operation 616). In one embodiment, the real-time distributed OLAP platform 214 determines these metrics upon the modified REPLY event record being added to the event record database 122 (e.g., the real-time distributed OLAP platform 214 detects that a new event record has been added to the event record database 122). Additionally and/or alternatively, the real-time distributed OLAP platform 214 determines the one or more metrics at predetermined time intervals (e.g., hourly, daily, weekly, etc.) using the event records of the event record database 122, including the modified REPLY event record. The real-time distributed OLAP platform 214 may then store the determined metrics in the analytic reporting information database 308 for later retrieval and presentation by the uniform presentation platform 216.

In this manner, the disclosed systems and methods provide various application(s) and/or platform(s) for monitoring and providing metrics about electronic communications sent among various members of an online service. Unlike conventional systems for sending electronic messages, the disclosed application(s) and/or platform(s) ensure that electronic messages are properly associated by maintaining separate event records for the electronic messages, where the event records correspond to various event record types. Furthermore, because the disclosed online architecture 112 implements a near real-time platform (e.g., the stream processing platform 208) and a scheduled processing platform (e.g., the distributed processing platform 210), the online architecture 112 can populate the generated event records with information that is volatile (e.g., known to change frequently) and with information that is non-volatile (e.g., known to change infrequently). By integrating different platforms to handle the process of generating and modifying event records to determine metrics for electronic messages communicated among members of an online service, the disclosed application(s) and/or platform(s) provide a technical solution that arises within the realm of electronic messaging and in computer networks.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a FPGA or an ASIC. A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 2-6 are implemented in some embodiments in the context of a machine and an associated software architecture. The sections below describe a representative architecture that is suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth, A slightly different hardware and software architecture may yield a smart device for use in the “internet of things” while yet another combination produces a server computer for use within a cloud computing architecture. Not all combinations of such software and hardware architectures are presented here as those of skill in the art can readily understand how to implement the inventive subject matter in different contexts from the disclosure contained herein.

### Example Machine Architecture and Machine-Readable Medium

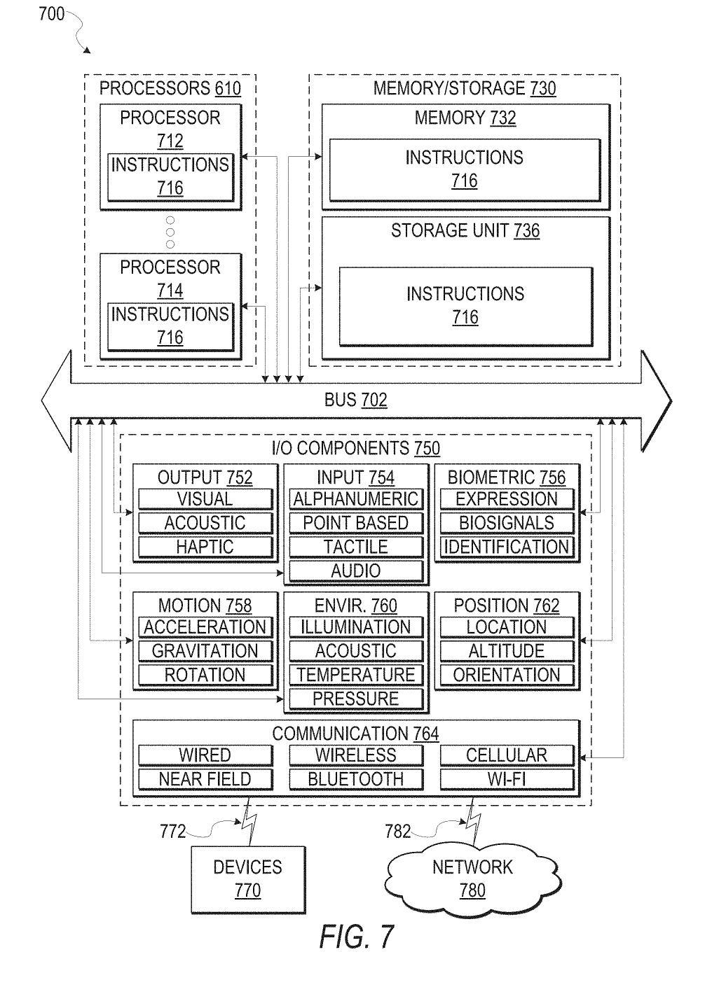

FIG. 7 is a block diagram illustrating components of a machine 600, according to some example embodiments, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein may be executed. For example, the instructions 716 may cause the machine 700 to execute the flow diagrams of FIGS. 5A-6. Additionally, or alternatively, the instructions 716 may implement one or more of the components of FIG. 2 and FIG. 3. The instructions 716 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to; a server computer, a client computer, a personal computer (PC), a tablet computer, a laptop computer, a netbook, a. PDA, or any machine capable of executing the instructions 716, sequentially or otherwise, that specify actions to be taken by machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory/storage 730, and I/O components 750, which may be configured to communicate with each other such as via a bus 702. In an example embodiment, the processors 710 (e.g., a Central Processing Unit (CPU), a Reduced instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, processor 712 and processor 714 that may execute the instructions 716. The term “processor” is intended to include multi-core processor that may comprise two or more independent processors (sometimes referred to as “cores”) that may execute instructions 716 contemporaneously. Although FIG. 7 shows multiple processors 710, the machine 700 may include a single processor with a single core, a single processor with multiple cores (e.g., a multi-core process), multiple processors with a single core, multiple processors with multiples cores, or any combination thereof.

The memory/storage 730 may include a memory 732, such as a main memory, or other memory storage, and a storage unit 736, both accessible to the processors 710 such as via the bus 702. The storage unit 736 and memory 732 store the instructions 716 embodying any one or more of the methodologies or functions described herein. The instructions 716 may also reside, completely or partially, within the memory 732, within the storage unit 736, within at least one of the processors 710 (e.g., within the processor's cache memory), or any suitable combination thereof, during execution thereof by the machine 700. Accordingly, the memory 732, the storage unit 736, and the memory of processors 710 are examples of machine-readable media.

As used herein, “machine-readable medium” means a device able to store instructions 716 and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 716. The term “machine-readable medium” shall also be taken to include any medium, or combination of multiple media, that is capable of storing instructions (e.g., instructions 716) for execution by a machine (e.g., machine 700), such that the instructions, when executed by one or more processors of the machine 700 (e.g., processors 710), cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The input/output (I/O) components 750 may include a wide variety of components to receive input, provide output, produce output, transmit information, exchange information, capture measurements, and so on. The specific I/O components 750 that are included in a particular machine will depend on the type of machine. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion and the grouping is in no way limiting. In various example embodiments, the I/O components 750 may include output components 752 and input components 754. The output components 752 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 750 may include biometric components 756, motion components 758, environmental components 760, or position components 762 among a wide array of other components. For example, the biometric components 756 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 758 may include acceleration sensor components (e.g., accelerometer), gravitation sensor components, rotation sensor components gyroscope), and so forth. The environmental components 760 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 762 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via coupling 782 and coupling 772, respectively. For example, the communication components 764 may include a network interface component or other suitable device to interface with the network 780. In further examples, communication components 764 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., a peripheral device coupled via a USB).

Moreover, the communication components 764 may detect identifiers or include components operable to detect identifiers. For example, the communication components 764 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF416, Ultra Code, UCC RSS-2D bar code, and other optical codes), or acoustic detection components (e.g., microphones to identify tagged audio signals). In addition, a variety of information may be derived via the communication components 764, such as location via Internet Protocol (IP) geo-location, location via Wi-Fi® signal triangulation, location via detecting a NEC beacon signal that may indicate a particular location, and so forth.

### Transmission Medium

In various example embodiments, one or more portions of the network 780 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 780 or a portion of the network 780 may include a wireless or cellular network and the coupling 782 may be a Code Division Multiple Access (CDMA) connection, a Global System for Mobile communications (GSM) connection, or other type of cellular or wireless coupling. In this example, the coupling 782 may implement any of a variety of types of data transfer technology, such as Single Carrier Radio Transmission Technology (1×RTT), Evolution-Data Optimized (ENDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 716 may be transmitted or received over the network 780 using a transmission medium via a network interface device (e.g., a network interface component included in the communication components 764) and utilizing any one of a number of well-known transfer protocols (e.g., hypertext transfer protocol (IMP)). Similarly, the instructions 716 may be transmitted or received using a transmission medium via the coupling 772 (e.g., a peer-to-peer coupling) to devices 770. The term “transmission medium” shall be taken to include any intangible medium that is capable of storing, encoding, or carrying instructions 716 for execution by the machine 700, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A system comprising:
a machine-readable medium storing computer-executable instructions; and
at least one hardware processor communicatively coupled to the machine-readable medium that, when the computer-executable instructions are executed, configures the system to:
receive a notification that a first electronic message has been sent to at least one recipient; the at least one recipient being a member of an online service;
generate a first event record associated with the first electronic message, the first event record being a first event record type that indicates that an electronic message has been sent;
modify the first event record to include one or more keywords associated with the at least one recipient of the first electronic message;
further modify the first event record to include member profile information associated with the at least one recipient of the first electronic message;
determine one or more metrics based on the modified first event record; and
provide a graphical user interface to a device, the graphical user interface comprising information based on the one or more metrics.

2. The system of claim 1, wherein the modification of the first event record comprises modifying the first event record to include one or more predetermined event record fields.

3. The system of claim 1, wherein the one or more keywords associated with the at least one recipient identify a member type of the online service to which the recipient belongs.

4. The system of claim 1, wherein the system is further configured to:
receive a notification that the at least one recipient has interacted with the first electronic message; and
generate a second event record associated with the interaction of the first electronic, the second event record having an event record type different than the event record type of the first event record.

5. The system of claim 4, wherein the system is further configured to modify the second event record by copying one or more event record field values from the first event record into the second event record.

6. The system of claim 4, wherein the second event record type indicates that the at least one recipient has replied to the first electronic message.

7. The system of claim 4, wherein the determined one or more metrics are further based on the second event record.

8. A method comprising:
receiving, by one or more hardware processors, a notification that a first electronic message has been sent to at least one recipient, the at least one recipient being a member of an online service;
generating, by the one or more hardware processors; a first event record associated with the first electronic message, the first event record being a first event record type that indicates that an electronic message has been sent;
modifying, by the one or more hardware processors, the first event record to include one or more keywords associated with the at least one recipient of the first electronic message;
further modifying, by the one or more hardware processors, the first event record to include member profile information associated with the at least one recipient of the first electronic message;
determining, by the one or more hardware processors, one or more metrics based on the modified first event record; and
providing, by the one or more hardware processors, a graphical user interface to a device, the graphical user interface comprising information based on the one or more metrics.

9. The method of claim 8, wherein modifying the first event record comprises modifying the first event record to include one or more predetermined event record fields.

10. The method of claim 8, wherein the one or more keywords associated with the at least one recipient identify a member type of the online service to which the recipient belongs.

11. The method of claim 8, further comprising:
receiving, by the one or more hardware processors, a notification that the at least one recipient has interacted with the first electronic message; and
generating, by the one or more hardware processors, a second event record associated with the interaction of the first electronic, the second event record having an event record type different than the event record type of the first event record.

12. The method of claim 11, further comprising:
modifying, by the one or more hardware processors, the second event record by copying one or more event record field values from the first event record into the second event record.

13. The method of claim 11, wherein the second event record type indicates that the at least one recipient has replied to the first electronic message.

14. The method of claim 11, wherein the determined one or more metrics are further based on the second event record.

15. A machine-readable medium storing computer-executable instructions which, when executed by one or more hardware processors, cause a system to perform a plurality of operations comprising:
receiving a notification that a first electronic message has been sent to at least one recipient, the at least one recipient being a member of an online service;
generating a first event record associated with the first electronic message; the first event record being a first event record type that indicates that an electronic message has been sent;
modifying the first event record to include one or more keywords associated with the at least one recipient of the first electronic message;
further modifying the first event record to include member profile information associated with the at least one recipient of the first electronic message;
determining one or more metrics based on the modified first event record; and
providing a graphical user interface to a device, the graphical user interface comprising information based on the one or more metrics.

16. The machine-readable medium of claim 15, wherein modifying the first event record comprises modifying the first event record to include one or more predetermined event record fields.

17. The machine-readable medium of claim 15, wherein the one or more keywords associated with the at least one recipient identify a member type of the online service to which the recipient belongs.

18. The machine-readable medium of claim 15, wherein the plurality of operations further comprise:
receiving a notification that the at least one recipient has interacted with the first electronic message; and
generating a second event record associated with the interaction of the first electronic, the second event record having an event record type different than the event record type of the first event record.

19. The machine-readable medium of claim 18, wherein the plurality of operations further comprise:
modifying the second event record by copying one or more event record field values from the first event record into the second event record.

20. The machine-readable medium of claim 18, wherein the second event record type indicates that the at least one recipient has replied to the first electronic message.
